(19) United States
(12) Patent Application Publication
(10) Pub. No.: US 2014/0172515 A1
(43) Pub. Date: Jun. 19, 2014

(54) Feed Creation For Use With Sales Force Automation And Collaboration Solutions

(71) Applicants: Sandra Schmidt, Bruchsal (DE); Vytas Cirpus, Waldsee (DE); Katharina Sorge, Rauenberg (DE); Steffen Schroeder, Heidelberg (DE); Thomas Schneider, Heidelberg (DE); Frank Freitag, Angelbachtal (DE); Kathrin Sindl, Nussloch (DE); Dirk Schindewolf, Karlsruhe (DE)

(72) Inventors: Sandra Schmidt, Bruchsal (DE); Vytas Cirpus, Waldsee (DE); Katharina Sorge, Rauenberg (DE); Steffen Schroeder, Heidelberg (DE); Thomas Schneider, Heidelberg (DE); Frank Freitag, Angelbachtal (DE); Kathrin Sindl, Nussloch (DE); Dirk Schindewolf, Karlsruhe (DE)

(21) Appl. No.: 13/716,185

(22) Filed: Dec. 16, 2012

(51) Int. Cl. G06Q 10/06

(52) U.S. Cl. CPC G06Q 10/06393
USPC 705/7.39

(57) ABSTRACT

Business users of a sales force automation solution can be enabled to receive updates and other relevant and timely information relating to key performance indicators (KPI) and other metrics via a news feed approach. A business user who is not directly registered to receive notifications about status changes in a particular data structure or business process can nonetheless be provided, via a feed bot service, with a feed content item generated upon detection of a status change in one or more data structures underlying one or more business processes of a customer organization using the sales force automation solution. The feed content item can relate to progress toward or achievement of a key performance indicator of the customer organization.

### TECHNICAL FIELD

The subject matter described herein relates to automated feed creation via a feed bot service for providing sales force automation and collaboration solution users with information about business progress.

### BACKGROUND

Many business users of sales force automation (SFA) solutions (e.g. SAP Sales OnDemand™ available from SAG AG of Walldorf, Germany, Sales Cloud™ available from Salesforce.com, Inc. of San Francisco, Calif., and the like) and similar business collaboration solutions can have business roles other than manager. Accordingly, such business users may not have access to reporting tools. However, these business users may nevertheless be interested in certain key performance indicators (KPIs) or other relevant metrics and desire to be informed actively (e.g. periodically, automatically, continuously, etc.) of changes in the values of such metrics. Metrics that can potentially be of interest to business users can include but are not limited to positive outcomes (e.g. closing of an important sale or other deal), negative outcomes (e.g. a stalled sales opportunity, refusal of an offer, etc.), and other information. Currently available solutions generally require a business user to actively register to one or more services that provide information under a defined situation (e.g. when a specific KPI is achieved).

### SUMMARY

The current subject matter can, among other potential advantages, provide beneficial results in keeping users of a sales force automation and/or collaboration solution better informed regarding key performance indicators or other relevant metrics. Consistent with implementations of the current subject matter, a feed relating to KPI achievements or other relevant metrics can be distributed or sent via a feed service, which can be referred to as a central feed service, a feed bot, or the like. Feed content can be triggered if a certain KPI, threshold, etc. has been reached.

In one aspect, a method includes detecting a status change relating to at least one instance of at least one data structure underlying at least one business process of a customer organization of a sales force automation solution, applying one or more feed content generation rules to the detected status change, and creating a feed content item based on the status change. The one or more feed content generation rules include a definition of a key performance indicator relating to a business outcome of the customer organization, and the feed content item relates to progress toward or achievement of the key performance indicator. A feed bot service provides the feed content item to business users registered with the feed bot service. The business users registered with the feed bot service include at least one business user who is not directly registered to receive notifications about status changes in the data structure or business process.

In some variations, one or more additional features can be included in any feasible combination. The business process can optionally relate to a sales opportunity of the customer organization. A custom icon can optionally be attached to the content item. The custom icon can optionally distinguish the feed content item as being delivered by the feed bot service. The feed bot service can optionally include a competitive win feed bot service, the feed content item can optionally include one or more details regarding an instance in which the customer organization won an opportunity against a competitor, and the one or more feed content generation rules can optionally include a definition of the competitor. The feed bot service can optionally include an automatic applause feed bot service, the feed content item can optionally include a one or more details regarding an instance in which an opportunity with a high volume was created for the customer organization, and the one or more feed content generation rules can optionally include a definition of the high volume. The feed bot service can optionally include a stalled opportunity feed bot service, the feed content item can optionally include one or more details regarding an opportunity of the registered user that has become stalled or is no longer progressing according to one or more defined metrics, and the one or more feed content generation rules can optionally include the one or more defined metrics.

Implementations of the current subject matter can include, but are not limited to, systems and methods including one or more features as described herein as well as articles that comprise a tangibly embodied machine-readable medium operable to cause one or more machines (e.g., computers, etc.) to result in operations described herein. Similarly, computer systems are also described that may include one or more processors and one or more memories coupled to the one or more processors. A memory, which can include a computer-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including but not limited to a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes in relation to an enterprise resource software system or other business software solution or architecture, it should be readily understood that such features are not intended to be limiting. The claims that follow this disclosure are intended to define the scope of the protected subject matter.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 is a screen shot of a sales flow automation application showing a contacts sub-screen including a display of available feed bots that a user can choose to follow;

FIG. 2 is a screen shot of a sales flow automation application showing an opportunities sub-screen including a display of sales opportunities being tracked for a user;

FIG. 3 is a screen shot of a sales flow automation application showing the opportunities sub-screen including a display of a window allowing updating of status and other information about one of the sales opportunities being tracked for the user;

FIG. 4 is a screen shot of a sales flow automation application showing a feed sub-screen including a display of feed content relating to an update made to the status of the sales opportunity in FIG. 3;

FIG. 5, FIG. 6, and FIG. 7 show screenshots of a metadata repository configuration application that can be used to define a feed bot service consistent with implementations of the current subject matter;

FIG. 8, FIG. 9, FIG. 10, and FIG. 11 show screenshots of a metadata repository configuration application that can be used to define a business object instance supporting a feed bot service consistent with implementations of the current subject matter;

FIG. 12 and FIG. 13 show screenshots of a business configuration application that can be used to define an operations of feed bot services consistent with implementations of the current subject matter;

FIG. 14 is a process flow diagram illustrating aspects of a method having one or more features consistent with implementations of the current subject matter;

FIG. 15 is a system diagram showing features of a computing architecture consistent with one or more implementations of the current subject matter; and

FIG. 16 is a system diagram showing features of another computing architecture consistent with one or more implementations of the current subject matter.

When practical, similar reference numbers denote similar structures, features, or elements.

### DETAILED DESCRIPTION

Implementations of the current subject matter can permit users of a sales force automation and/or collaboration solution to register to a feed bot that provides feed content relating to a business document, business object, or other data structure or representation of a business outcome. For the purposes of this disclosure, the term “business document” refers generally to any type of other data structure or representation of a business outcome, including but not limited to those discussed specifically herein. The feed content can be provided to the user even if the user is not specifically following or otherwise subscribed to a feed or other news sources directly or indirectly relating to the business document itself. Some non-limiting examples of feed bots consistent with one or more implementations of the current subject matter can include a “competitive win” feed bot, an “automatic applause” feed bot, a “my stalled opportunity” feed bot, and the like.

As illustrative examples, a “competitive win” feed bot can provide to all users registered to it a feed that details instances in which an opportunity was won against a configured competitor. An “automatic applause” feed bot can provide to all users registered to it a feed that details instances in which an opportunity with an extremely high (configured) volume was created. A “my stalled opportunity” feed bot can provide to all users registered to it a feed that details instances in which an opportunity of that registered user becomes stalled or otherwise is no longer progressing according to one or more defined metrics.

A customer organization using a sales force automation and/or collaboration solution can in some implementations of the current subject matter purchase an add-on, module, extra feature set, service, or the like that provides one or more features of the functionality described herein. For the remainder of this disclosure, a “feed bot service” is used to refer to any type of computer-implemented functionality that supports one or more of the features relating to feed content delivery described herein or other similar or functionally equivalent features.

A customer organization (e.g. one or more managers or other key users at a customer organization that has purchased, licensed, etc. a sales force automation and/or collaboration solution) can activate, configure, etc. a feed bot service via a business configuration user interface or the like. For the purposes of this disclosure, a business user refers to an end user of a sales force automation and/or collaboration solution. For example, a business user can be a sales associate, a sales contractor, a manager, a trainee, another member of the customer organization, or the like. A business user can register to a feed bot service or be registered automatically (optionally with the option to unregister from the feed bot service is the business user no longer wishes to receive feed content from the feed bot service). In one example, a feed bot service can be represented as a “pseudo business partner” or other contact that can be added to a business user's list of “followees” or other content generators to whom or to which the business user subscribes. The feed bot service can perform similarly to other content generators in that the business user can register (e.g., follow, subscribe to, etc.) or unregister (e.g., stop following, unsubscribe from, etc.).

The current subject matter differs from other currently available approaches to content distribution in that content provided by a feed bot service can make content relating to KPIs and other milestones or metrics available to business users who have not expressly subscribed or registered to receive feeds relating to specific projects, goals, etc. or to the underlying data or business object structures relating to such specific projects, goals, etc. In contrast, a system feed or similar functionality that enables a business user to follow changes on a specific business object or other data structure underlying a business process (e.g. a sales opportunity, etc.) would generally provide content to the business user only to the extent that the content is directly related to those business objects to which the business user has registered or subscribed. Therefore, for a business user to remain informed about all KPI outcomes or other metrics across a larger group of projects or outcomes, the business user would need to register or subscribe to each of the feeds generated by the specific business objects or other underlying data structures. Doing so could conceivably inundate the business user with a significant amount of unwanted information in addition to the KPI or other metric outcome content.

Another currently available approach that does provide one or more of the advantages that can be realized with implementations of the current subject matter is user feeds that enable a business user of a SFA or other comparable solution to send a public feed to followers. Another business user who registers or subscribes to a user feed provided in this manner receives content added to the feed by the originating business user. However, this content may not include all relevant KPI or other metric outcomes and may also be substantially untargeted (e.g. additional content that is not relevant to KPI or other metric outcomes). Reporting tools designed to enable managers or key user to evaluate KPIs or other metric outcomes tend to not be useful in providing advantages that can result from use of implementations of the current subject matter at least because such reporting tools are more typically inclusive of content that may not be appropriate for dissemination to business users at below a manger level.

Implementations of the current subject matter can enable a business user to follow certain situations (e.g. KPIs, other relevant metrics, etc.) by registering to (e.g., following, subscribing to, etc.) a feed bot service, which can be maintained centrally and which can incorporate content from other feeds to which the business user might or might not have also subscribed or registered with. Each feed bot service can optionally be directed toward content meeting a certain set of criteria, such as for example those noted above or other criteria or parameters that can optionally be configurable within a customer organization (e.g., by a manager or key user at or within the customer organization). To receive relevant content, the business user is not required to follow the changes of a specific business object or other data structure underlying an outcome, business process, or the like (e.g. an opportunity). The business user also need not proactively evaluate reports to find out if a certain KPI has been reached. Additionally, a feed bot service consistent with implementations of the current subject matter can receive content simply by automatically monitoring changes to transactional data or other aspects of a business object or other data structure underlying an outcome business process, or the like. As such, content relating to the target KPI or other relevant metric to which a specific feed bot service is directed can be generated automatically and immediately upon occurrence of such a business process, or the like. This feature can lead to very quick generation of content that can keep business users who are subscribed or registered to or otherwise following a feed bot service well-informed of relevant developments even without content being generated by a manager or other person for a news feed or other conventional content reporting service.

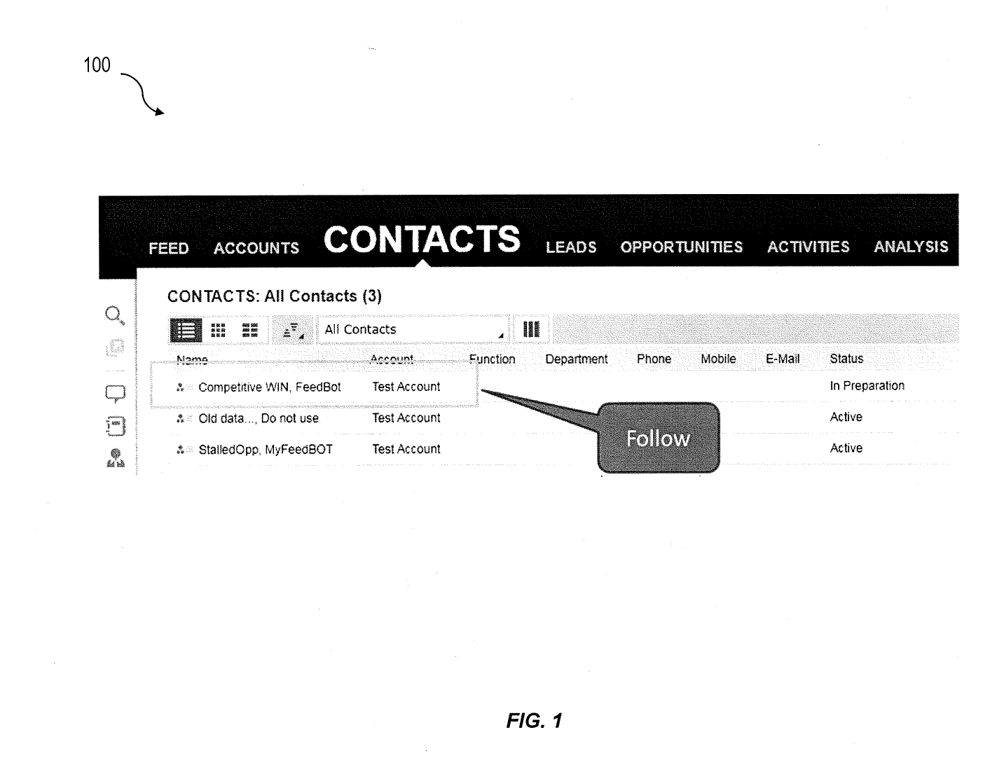

FIG. 1 shows a screenshot 100 illustrating user interface functionality that can be included in a feed bot definition feature. As noted above, a feed bot service consistent with implementations of the current subject matter can be presented to a business user in a manner similar to contacts in a contact list or as any other content provider in a content provider list. In this context, a contact can be thought of as a service agent used as a sender of feeds. Each business user can be allowed to register or unregister from one or more specific fee bot services in the same manner that he or she can register or unregister from any other content provider that generates a feed. As an example, it is possible that not every business user is interested in receiving the content of all possible feed bot services. A particular user may wish to receive only a specific type of content, for example excluding positive news such that he or she is alerted by receiving content from a feed bot service only when a negative outcome is reflected in a KPI or other relevant metric.

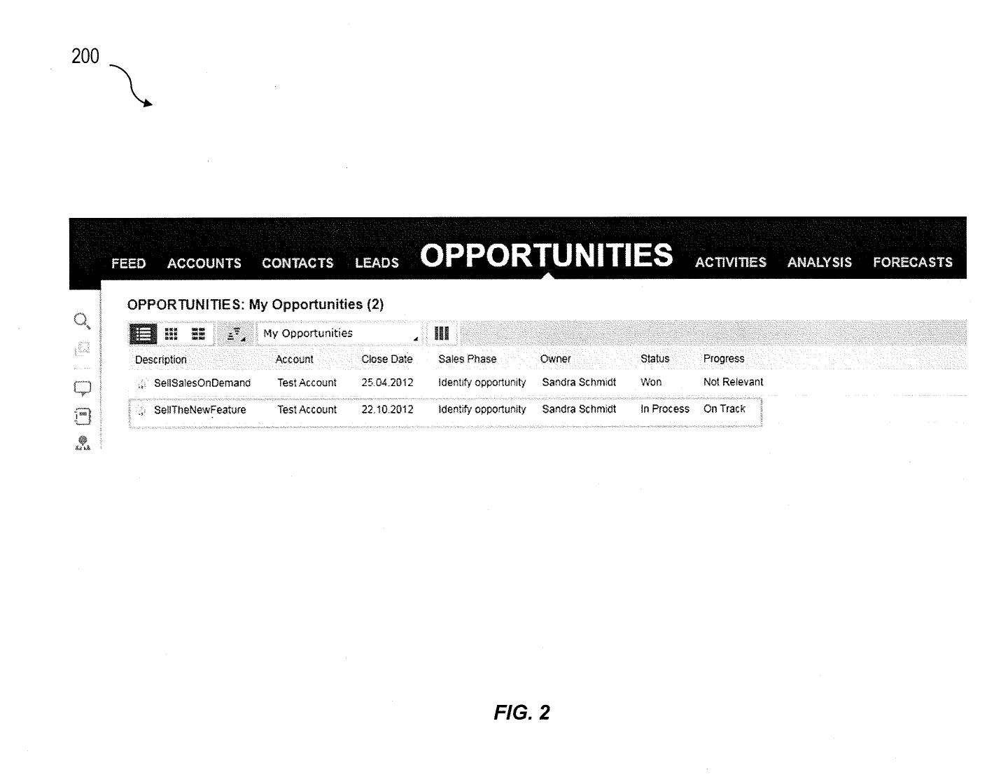

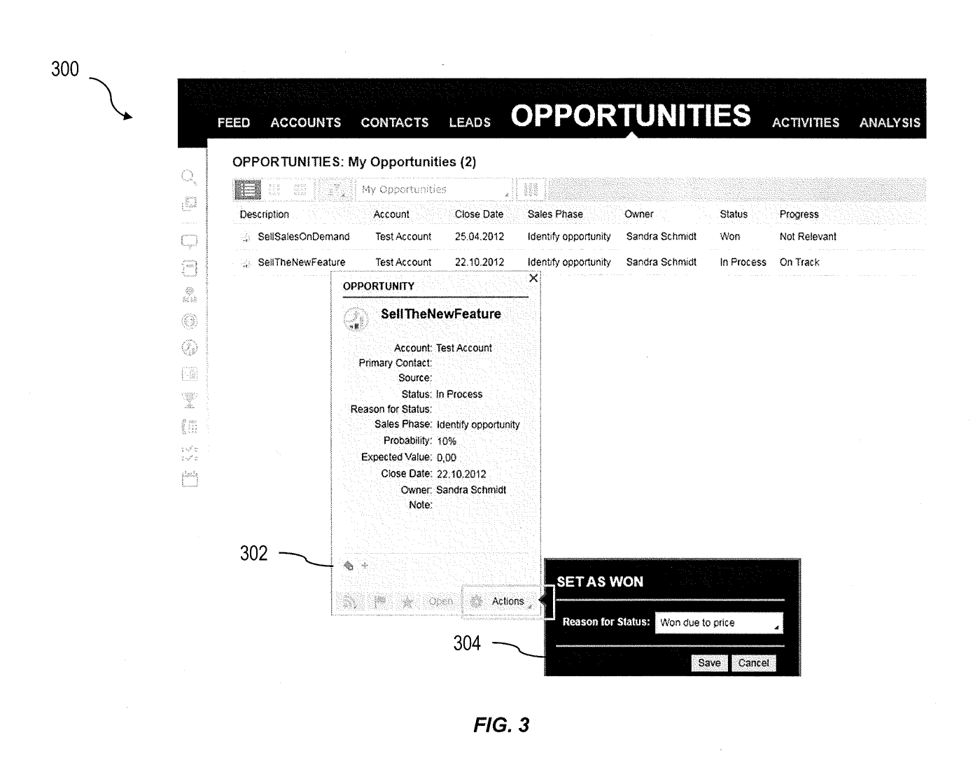

FIG. 2 shows a screenshot 200 illustrating an opportunities list functionality that can be presented in a currently available SFA solution. Each sales opportunity “owned” or controlled by a given business user can be displayed in a list that can optionally provide status information, progress information, etc. FIG. 3 shows a screenshot 300 illustrating use of the opportunities list by a business user to indicate a change to a status indicator relating to a business process, outcome, or the like “owned” by the business user. As shown in the example of FIG. 3, the business user can open a detail panel 302 that provides a view on status and/or other data relating to an opportunity (e.g. a sales opportunity, a project, or any other business process including but not limited to business processes that can have a defined KPI or other outcome metric). Within the detail panel, the user can open a sub-panel 304 for receiving user input relating to status of the opportunity.

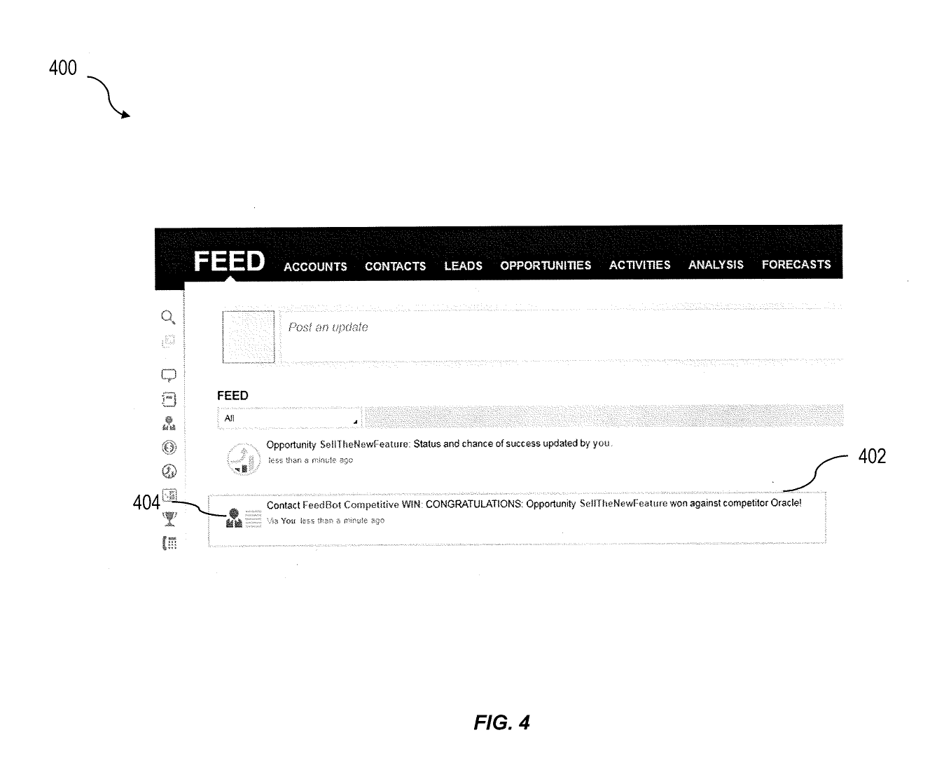

FIG. 4 shows a screenshot 400 illustrating a feed view that can be made available to business users of a SFA or other comparable solution. In this example, the feed content displayed to the business user can be incremented with a new entry 402 sent by a feed bot service directed to competitive wins that has been automatically updated due to the change in status entered in the sub-panel 304 discussed above in reference to FIG. 3. In some implementations of the current subject matter, a custom icon 404 can be attached to content items generated by a feed bot service such as those discussed herein, for example for distinguishing the feed content item as belonging to that particular feed bot service.

In some implementations of the current subject matter, features supporting a feed bot service can be provided via one or more feed content generation functionalities. In one example, a feed content generation functionality can include an extension business object or other data structure configurable by a customer organization, for example using a partner development infrastructure (PDI), customer development toolkit, or the like. In an example, an extension business object or other data structure can be attached to or otherwise implemented on an opportunity business object that underlies a sales or other business opportunity.

When a change is detected to a business object or other data structure that has been defined as relevant to a KPI or other metric of interest, a check can be performed, for example by the extension business object or other data structure configurable by the customer organization, to determine whether feed content needs to be sent via a feed bot service. The check can include comparing the detected change to one or more rules or other criteria, which can be stored as metadata defining one or more aspects of business logic as defined either generically or specific to the customer organization. In some implementations of the current subject matter, a feed content item can be sent using a transformation definition or business object action.

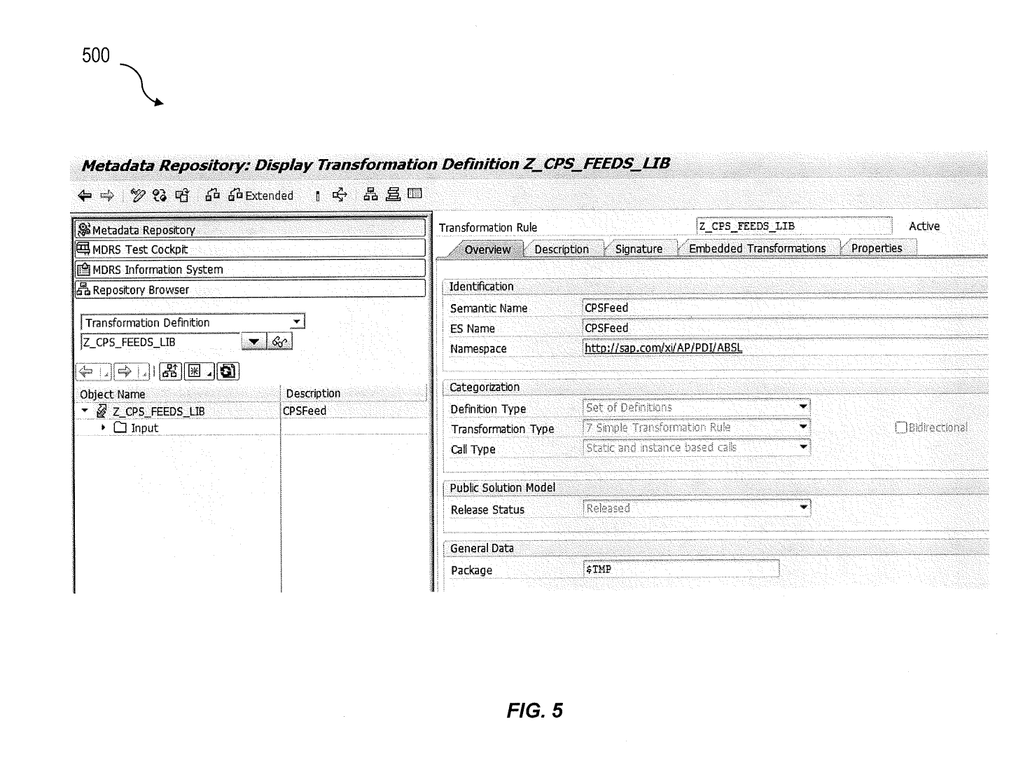

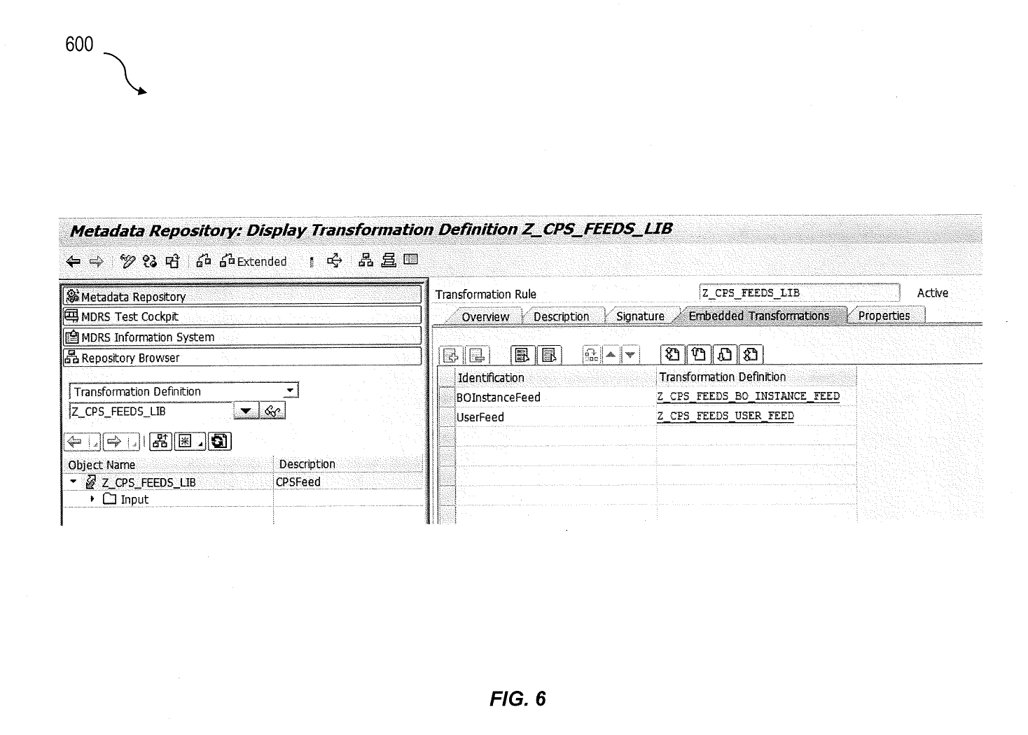

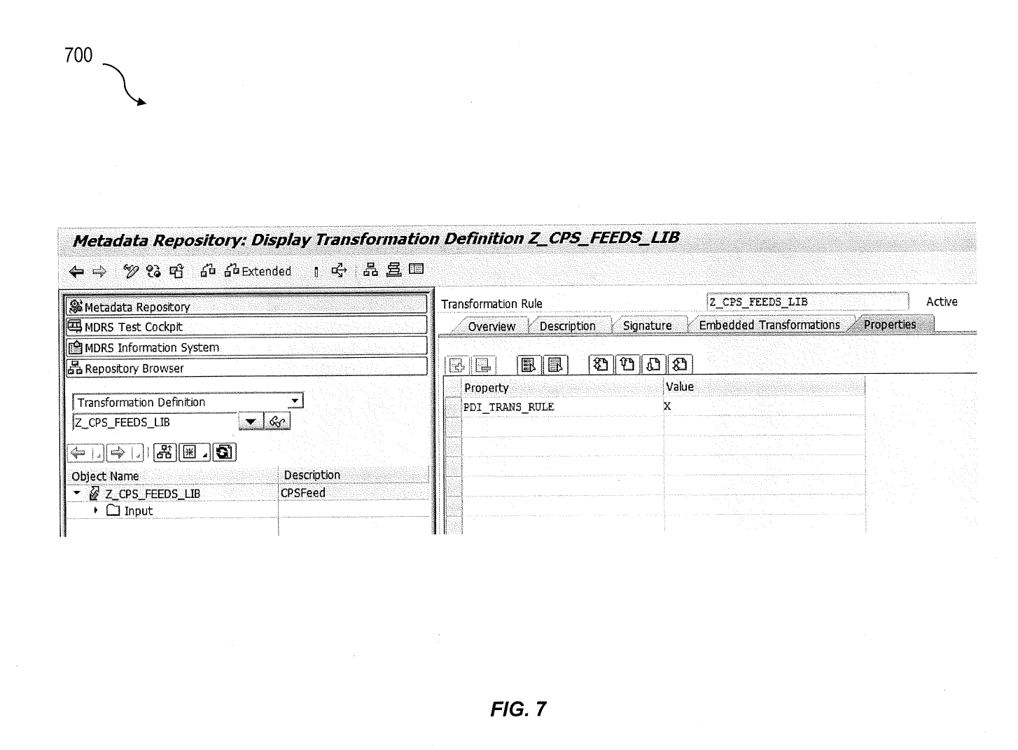

FIG. 5, FIG. 6, and FIG. 7 show screenshots 500, 600, and 700 illustrating aspects of a technical infrastructure that can be used in conjunction with an extension business object approach to a feed content generation functionality. In the illustrated example, a transformation definition for an extension business object can be defined by a user at the customer organization. The screenshot 500 in FIG. 5 shows content of an overview tab for a definition of a feed bot service, while the screenshot 600 of FIG. 6 shows content of an embedded transformations tab for a definition of a feed bot service. The screenshot 700 in FIG. 7 shows content of a properties tab for a definition of a feed bot service.

In other implementations of the current subject matter, a feed content generation functionality can include an outbound agent optionally created using a partner development infrastructure (PDI), customer development toolkit, or the like. The outbound agent can be attached or otherwise implemented on an opportunity business object that underlies a sales or other business opportunity.

When a change is detected to a business object or other data structure that has been defined as relevant to a KPI or other metric of interest, a check can be performed, for example by the outbound agent, to determine whether feed content needs to be sent via a feed bot service. The check can include comparing the detected change to one or more rules or other criteria, which can be stored as metadata defining one or more aspects of business logic as defined either generically or specific to the customer organization. In some implementations of the current subject matter, a feed content item can be generated by sending a message to create a new instance of a business object or other data structure that sends feed content asynchronously.

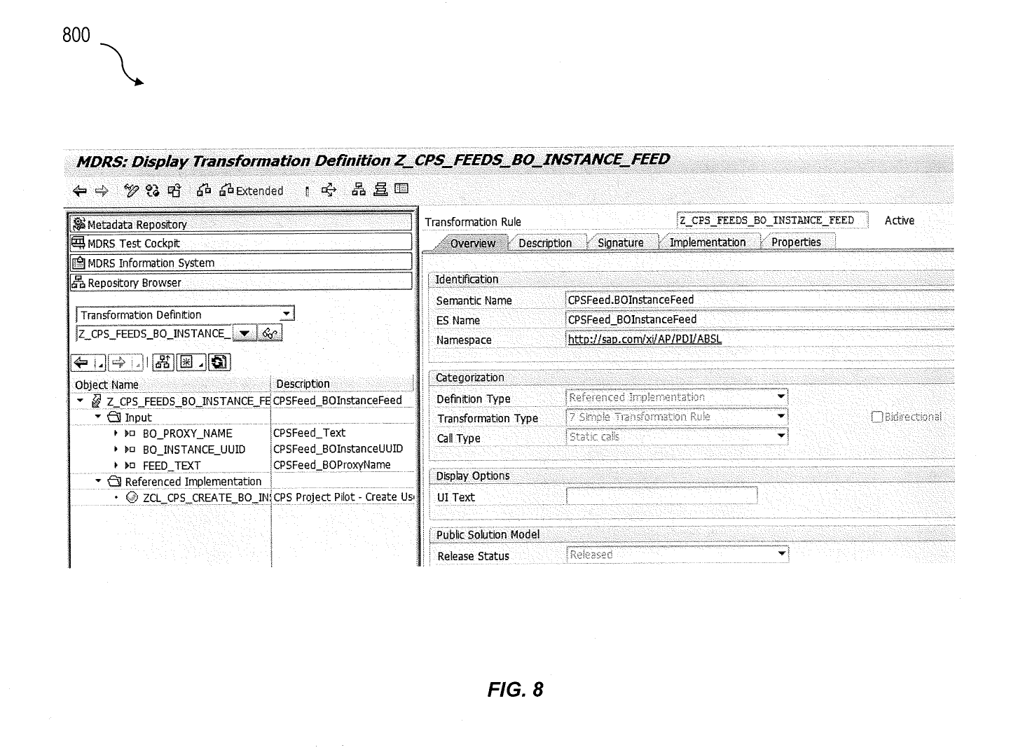

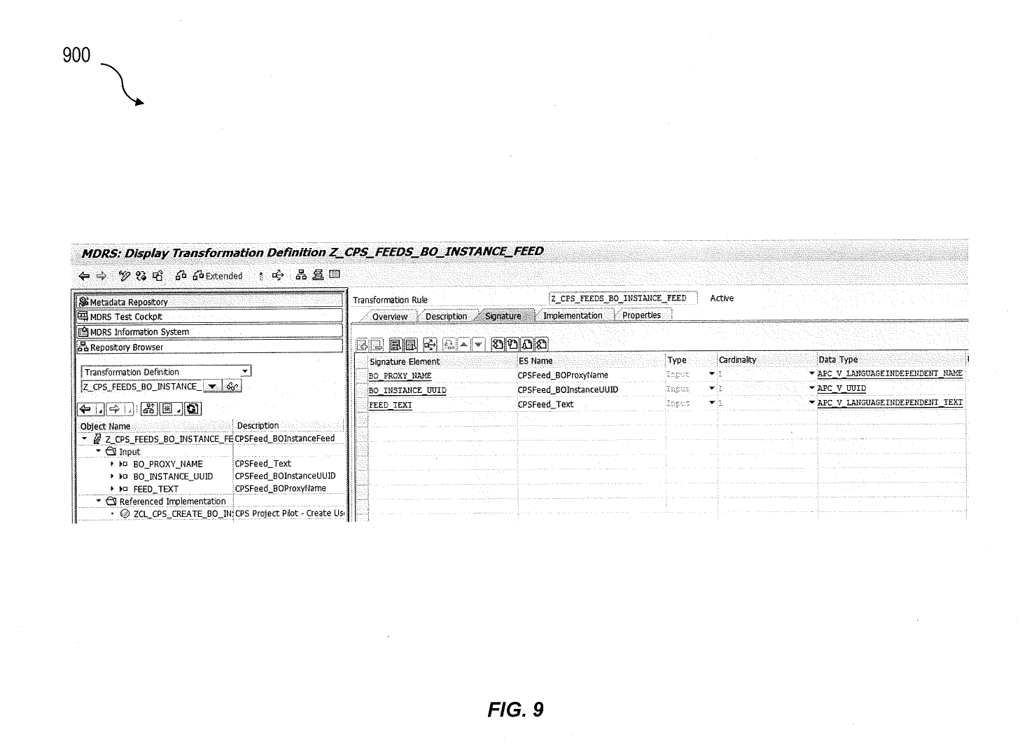

FIG. 8, FIG. 9, and FIG. 10 show screenshots 800, 900, and 1000 illustrating aspects of a technical infrastructure that can be used in conjunction with an outbound agent approach to a feed content generation functionality. The screenshot 800 in FIG. 8 shows content of an overview tab for a definition of a business object instance supporting a feed bot service. The screenshots 900, 1000, and 1100 of FIG. 9, FIG. 10, and FIG. 11, respectively, show content of a signature tab for a definition of a business object instance supporting a feed bot service, content of an implementation tab for a definition of a business object instance supporting a feed bot service, and content of a properties tab for a definition of a business object instance supporting a feed bot service. Using an approach similar to that illustrated in this series of screenshots, an ability to create feeds on change of opportunity can be provided. A feed business object can create feeds based on information available for one specific opportunity.

Consistent with various features of the feed content generation functionality, a configuration business object or other data structure can also be included to allow a business user (in some examples a manager or key user) to define one or more parameters of a KPI or other relevant metric. Additionally, an instance of a business object or other data structure can be provided to send the feed content and to be available for receiving and implementing registering or unregistering requests from business users.

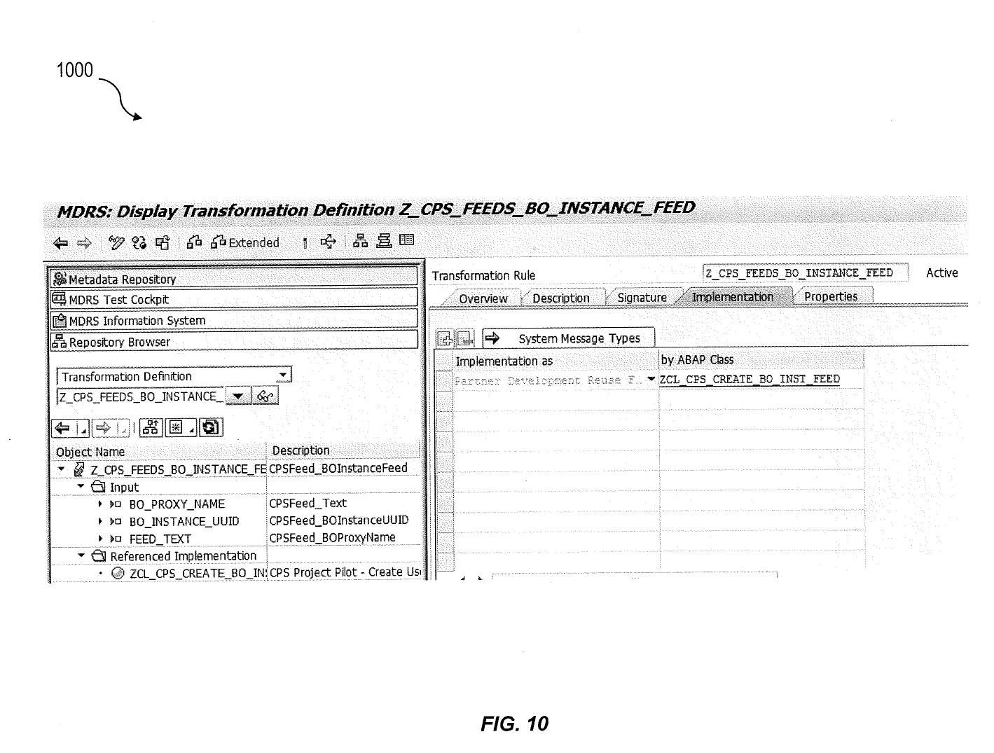

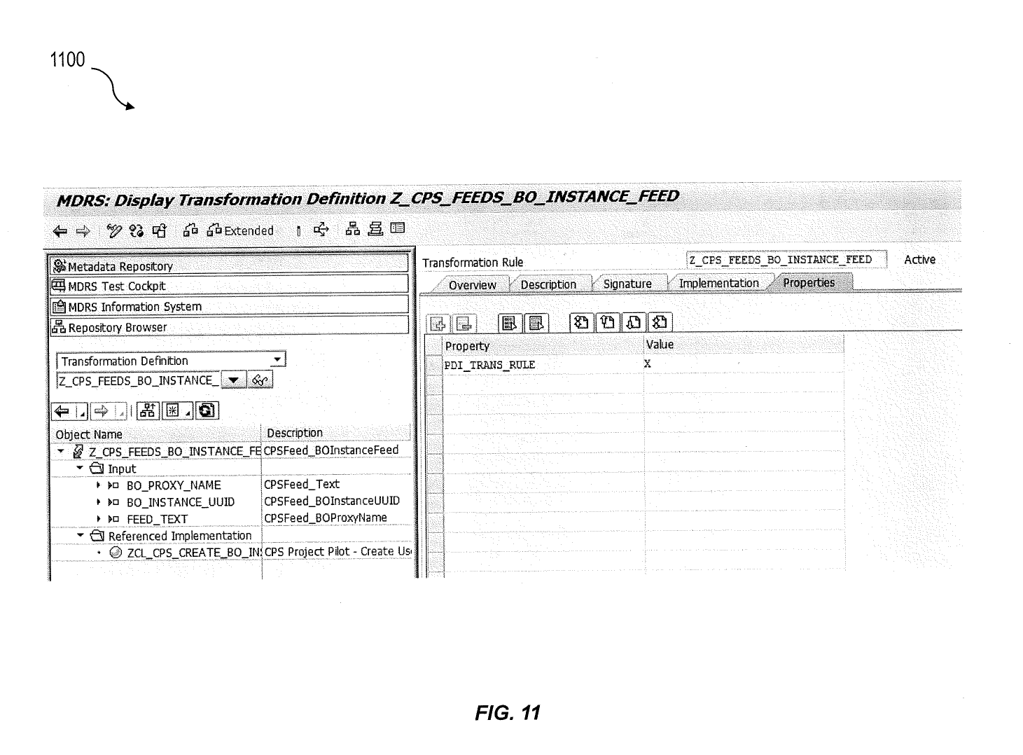

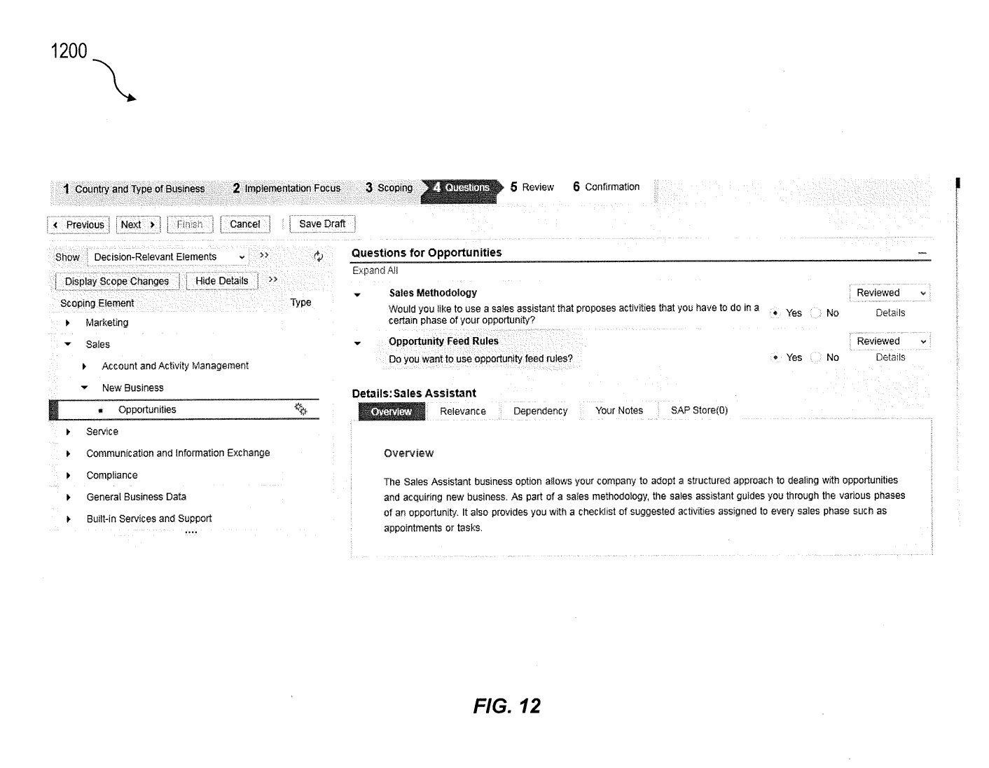

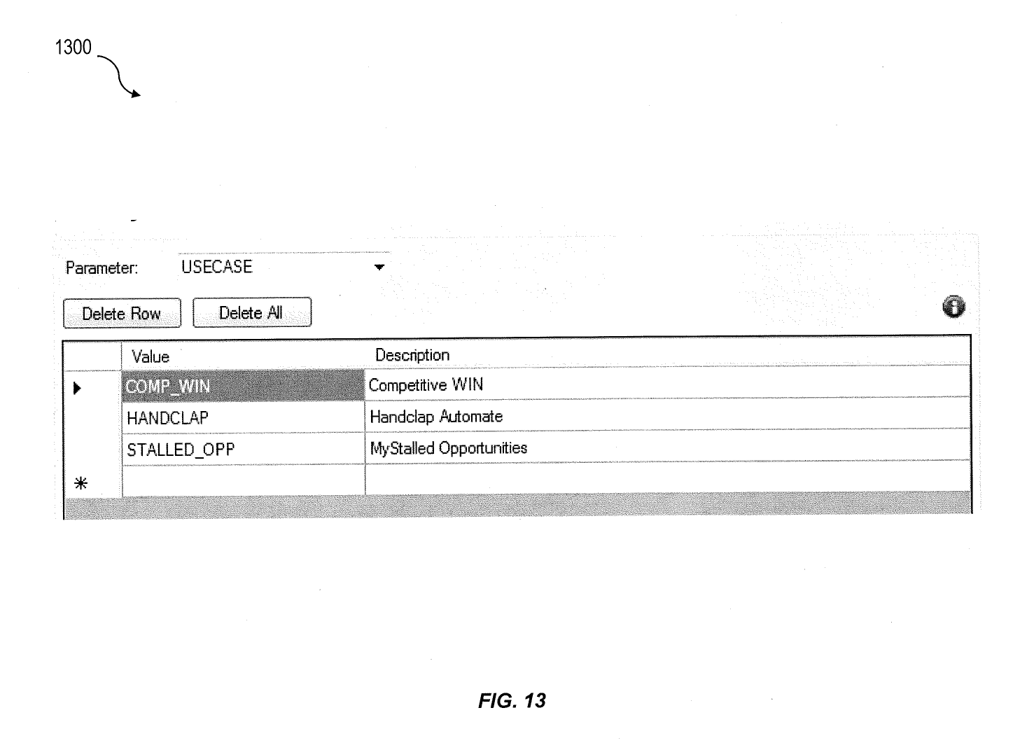

Each KPI or other relevant metric to be monitored for inclusion as feed content in a feed bot service can have a definition, which can be specific to a given customer organization. A manager, key user, or other responsible party at the customer organization, etc. can define the business objects, fields, other data structures, etc. that need to be checked, calculated, etc. to generate content for a specific feed bot service. FIG. 12 shows a screenshot 1200 that illustrates features of a business configuration user interface that can be used to define rules (which can optionally be stored as metadata) for generating feed content for a feed bot service based on detected changes to business objects or business object instances underlying business outcomes (e.g. sales opportunity status changes or the like). The example shown in the screenshot 1200 can query a manager, key user, etc. for parameters to be used to define content generation for a feed bot service. FIG. 13 shows a screenshot 1300 that illustrates features allowing a manager, key user, etc. to determine the fee bot services to be activated for a given business configuration. This feature can allow setting of default set of feed bot services that each business user is registered to. Individual business users can choose to unregister from one or more of the default set of feed bot services or register to one or more additional feed bot services not in the default set.

In some implementations of the current subject matter, a SFA or similar solution may receive migrated data from another, previously used solution, for example as part of an upgrade of systems or a change in vendors of the SFA solution used by a customer organization. Implementations of the current subject matter can include a default block on generation of content for automated feed bot services such as those described herein for data that are being migrated. This capability can prevent business users from being inundated with a rush of untimely content that would otherwise be generated as “new” based on the data structure updates being migrated into the system.

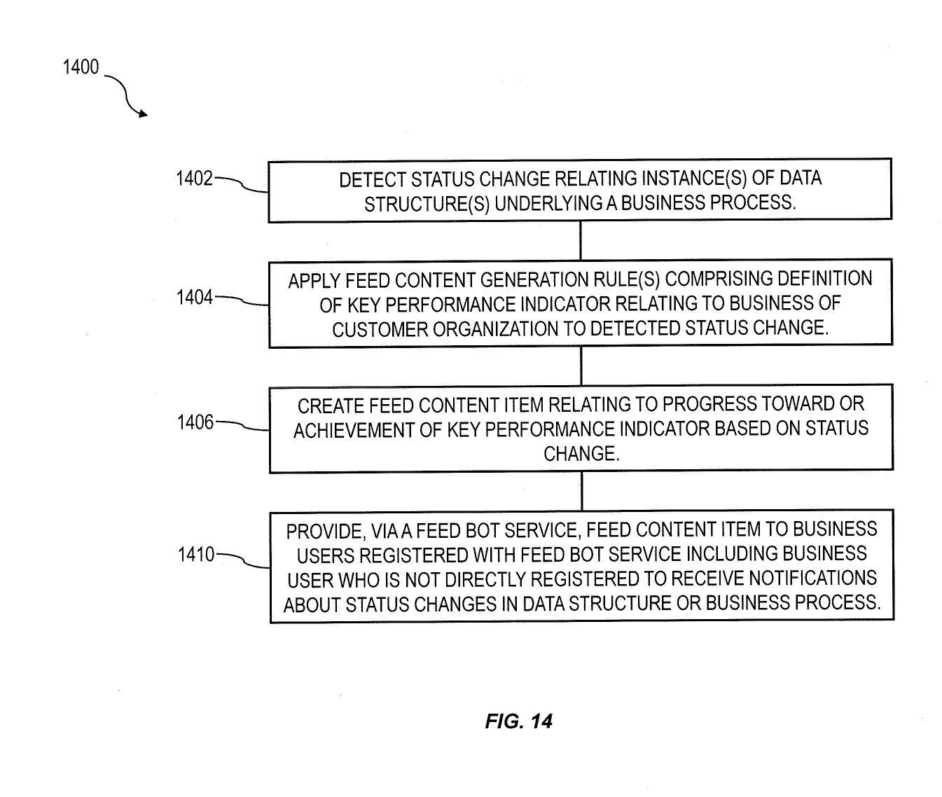

FIG. 14 shows a process flow chart 1400 illustrating features of a method. One or more of these features can be included in implementations of the current subject matter. At 1402, a status change relating to at least one instance of a data structure underlying a business process is detected. The status change can be consistent with or similar to descriptions of status changes discussed above. At 1404, one or more feed content generation rules are applied to the detected status change. The one or more feed content generation rules include a definition of a key performance indicator relating to a business of a customer organization using a sales force automation solution. The sales force automation solution can, as noted above, include one or more of a SFA solution or other business collaboration solution. At 1406, a feed content item is created based on the status change. The creating occurs automatically. The feed content item relates to progress toward or achievement of the key performance indicator. At 1410, the feed content item is provided via a feed bot service to business users registered with the feed bot service. The business users registered with the feed bot service (and therefore receiving the feed content item) include at least one business user who is not directly registered to receive notifications about status changes in the data structure or business process.

Implementations of the current subject matter can provide one or more advantages relative to previously available solutions. For example, the ability to rapidly, accurately, and automatically generate and distribute content relating to business outcomes can be useful as a motivator for sales representatives and other employees who are results driven. By providing immediate feedback on outcomes as defined by KPIs and other relevant metrics that can be defined specific to a customer organization, basic human emotions such as fear and pride can be tapped as drivers for improved performance. Additionally, business users of the feed bot services can find benefits in receiving immediate feedback regarding progress toward business goals in an automated manner. This feature can mitigate feelings of concern or dread that surprising bad news might be delivered by a manager. Instead, the business user can immediately know the status of important metrics. Feed bot services consistent with implementations of the current subject matter can be created to provide business outcome feedback about a specific project or opportunity. Alternatively, feed bot services can provide an aggregated content feed about a group of projects or business opportunities, and can thereby derive data for generated content by detecting changes in status or other transactional data for a group of underlying business objects or other data structures. Content provided to a business user's feed by a feed bot service can optionally be associated with a specific avatar having a chosen appearance

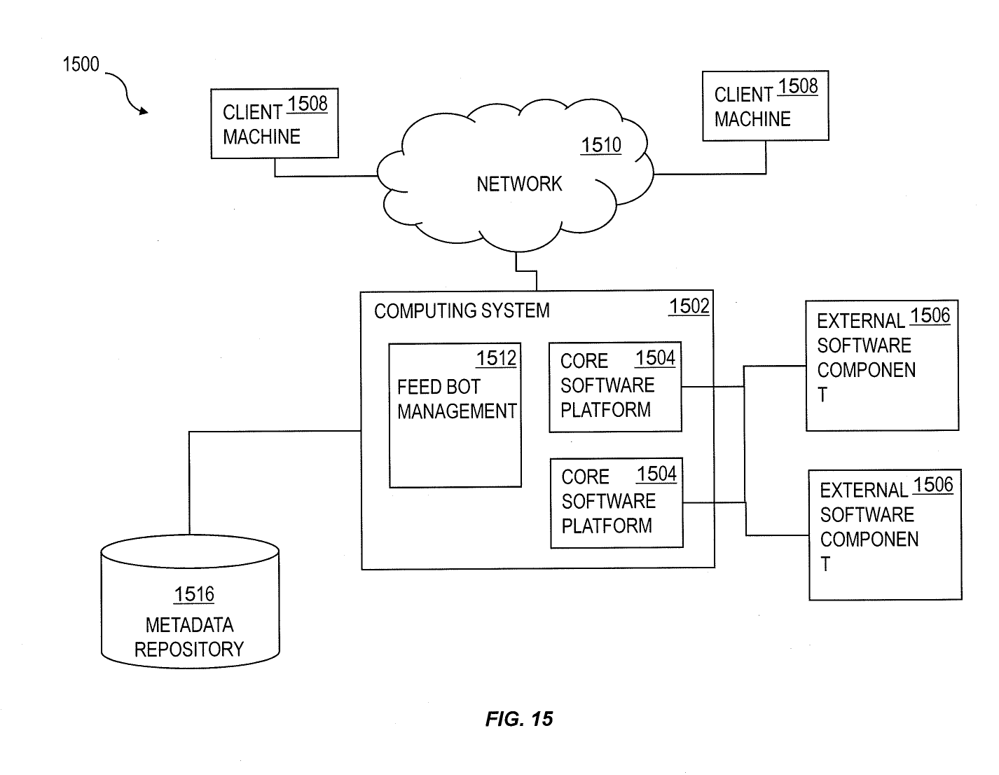

The core software platform of SFA solution, other business collaboration solution system, other business software architecture, or the like can be provided as a standalone, customized software installation that runs on one or more processors that are under the control of the organization. This arrangement can be very effective for a large-scale organization that has very sophisticated in-house information technology (IT) staff and for whom a sizable capital investment in computing hardware and consulting services required to customize a commercially available business software solution to work with organization-specific business processes and functions is feasible. FIG. 15 shows a diagram of a system consistent with such an implementation. A computing system 1502 can include one or more core software platform modules 1504 providing one or more features of the business software system. The computing system can also aggregate or otherwise provide a gateway via which users can access functionality provided by one or more external service providers 1506. Client machines 1508 can access the computing system, either via a direct connection, a local terminal, or over a network 1510 (e.g. a local area network, a wide area network, a wireless network, the Internet, or the like). A feed bot service module or other comparable functionality 1512 can be hosted on the computing system 1502 or alternatively, on an external system accessible over a network connection. The feed bot service module or other comparable functionality 1512 can optionally include one or more discrete software and/or hardware modules that perform operations such as those described herein.

The feed bot service module or other comparable functionality 1512 can access one or more metadata repositories and/or other data repositories 1516 (e.g. process repositories, scenarios repositories, transactional data repositories, etc.) that can store definitions of business scenarios, business processes, and one or more business configurations as well as data, metadata, master data, etc. relating to definitions of the business scenarios, business processes, and one or more business configurations, and/or concrete instances of the data objects (e.g. business objects) that are relevant to a specific instance of the business scenario or a business process. In some examples, the definition can optionally be stored as a business object. In some implementations, the business object can store a business object that represents a template definition of a standard business process or that other underlies a sales opportunity, business project, or the like. The template definition that can optionally be modified via one or more extensions that are stored in the one or more metadata repositories 1516.

Smaller organizations can also benefit from use of business software functionality. However, such an organization may lack the necessary hardware resources, IT support, and/or consulting budget necessary to make use of a standalone business software software architecture product and can in some cases be more effectively served by a software as a service (SaaS) arrangement in which the business software system architecture is hosted on computing hardware such as servers and data repositories that are maintained remotely from the organization's location and accessed by authorized users at the organization via a thin client, such as for example a web browser, over a network.

In a software delivery configuration in which services of a business software system are provided to each of multiple organizations are hosted on a dedicated system that is accessible only to that organization, the software installation at the dedicated system can be customized and configured in a manner similar to the above-described example of a standalone, customized software installation running locally on the organization's hardware. However, to make more efficient use of computing resources of the SaaS provider and to provide important performance redundancies and better reliability, it can be advantageous to host multiple tenants on a single system that includes multiple servers and that maintains data for all of the multiple tenants in a secure manner while also providing customized solutions that are tailored to each tenant's business processes.

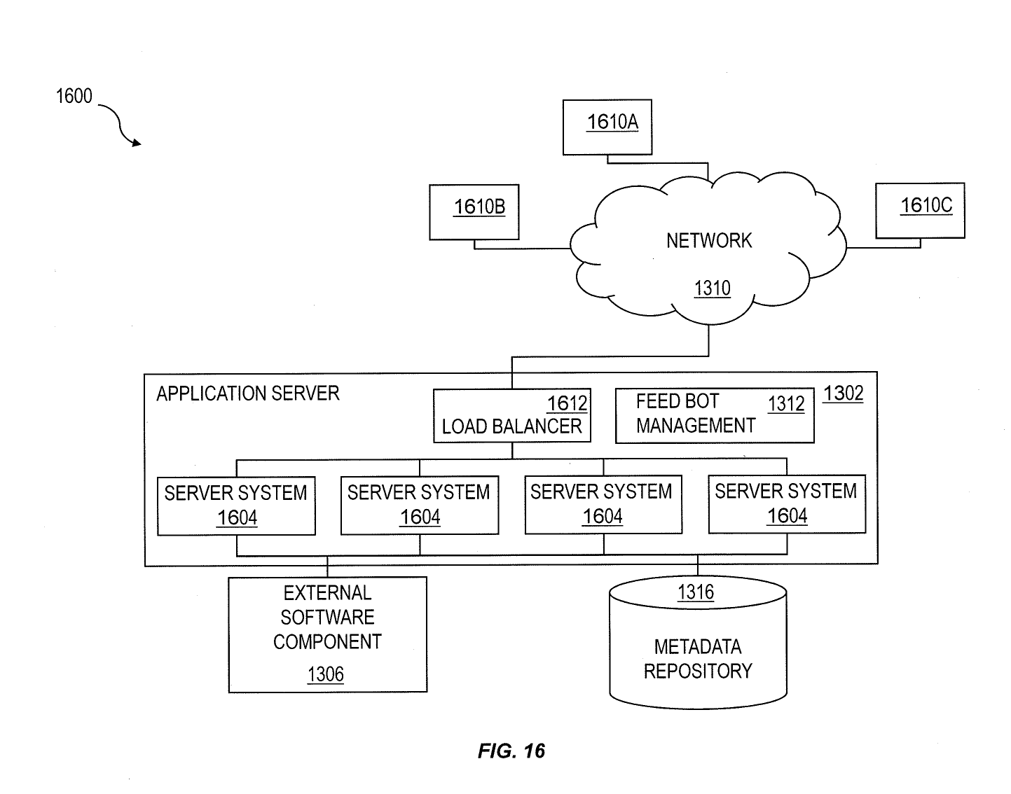

FIG. 16 shows a block diagram of a multi-tenant implementation of a software delivery architecture 1600 that includes an application server 1602, which can in some implementations include multiple server systems 1604 that are accessible over a network 1606 from client machines operated by users at each of multiple organizations 1610A-1610C (referred to herein as “tenants” of a multi-tenant system) supported by a single software delivery architecture 1600. For a system in which the application server 1602 includes multiple server systems 1604, the application server can include a load balancer 1612 to distribute requests and actions from users at the one or more organizations 1610A-1610C to the one or more server systems 1604. Instances of the core software platform 1504 can be executed in a distributed manner across the server systems 1604. A user can access the software delivery architecture across the network using a thin client, such as for example a web browser or the like, or other portal software running on a client machine. The application server 1602 can access data and data objects stored in one or more data repositories 1516. The application server 1602 can also serve as a middleware component via which access is provided to one or more external software components 1506 that can be provided by third party developers.

A multi-tenant system such as that described herein can include one or more of support for multiple versions of the core software and backwards compatibility with older versions, stateless operation in which no user data or business data are retained at the thin client, and no need for tenant configuration on the central system. As noted above, in some implementations, support for multiple tenants can be provided using an application server 1602 that includes multiple server systems 1604 that handle processing loads distributed by a load balancer 1612. Potential benefits from such an arrangement can include, but are not limited to, high and reliably continuous application server availability and minimization of unplanned downtime, phased updating of the multiple server systems 1604 to permit continuous availability (one server system 1604 can be taken offline while the other systems continue to provide services via the load balancer 1612), scalability via addition or removal of a server system 1604 that is accessed via the load balancer 1612, and de-coupled lifecycle processes (such as for example system maintenance, software upgrades, etc.) that enable updating of the core software independently of tenant-specific customizations implemented by individual tenants.

As in the example illustrated in FIG. 15, the metadata repository 1516 can store a business object that represents a template definition of a standard business process or that other underlies a sales opportunity, business project, or the like. Each individual tenant 1610A-1610C can customize that standard template according to the individual business process features specific to business of the organization to which that tenant is assigned. Customizations can be stored as extensions in the metadata repository.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed:

1. A computer program product comprising a computer-readable storage medium storing one or more programs, the one or more programs comprising instructions that, when executed by at least one programmable processor, cause the at least one programmable processor to perform operations comprising:
detecting a status change relating to at least one instance of at least one data structure underlying at least one business process of a customer organization of a sales force automation solution;
applying one or more feed content generation rules to the detected status change, the one or more feed content generation rules comprising a definition of a key performance indicator relating to a business outcome of the customer organization;
creating a feed content item based on the status change, the feed content item relating to progress toward or achievement of the key performance indicator; and
providing, via a feed bot service, the feed content item to business users registered with the feed bot service, the business users registered with the feed bot service comprising at least one business user who is not directly registered to receive notifications about status changes in the at least one data structure or business process.

2. A computer program product as in claim 1, wherein the business process relates to a sales opportunity of the customer organization.

3. A computer program product as in claim 1, wherein the operations further comprise attaching a custom icon to the content item, the custom icon distinguishing the feed content item as being delivered by the feed bot service.

4. A computer program product as in claim 1, wherein the feed bot service comprises a competitive win feed bot service, the feed content item comprises one or more details regarding an instance in which the customer organization won an opportunity against a competitor, and the one or more feed content generation rules comprises a definition of the competitor.

5. A computer program product as in claim 1, wherein the feed bot service comprises an automatic applause feed bot service, the feed content item comprises one or more details regarding an instance in which an opportunity with a high volume was created for the customer organization, and the one or more feed content generation rules comprises a definition of the high volume.

6. A computer program product as in claim 1, wherein the feed bot service comprises a stalled opportunity feed bot service, the feed content item comprises one or more details regarding an opportunity of the at least one business user that has become stalled or is no longer progressing according to one or more defined metrics, and the one or more feed content generation rules comprises the one or more defined metrics.

7. A system comprising:
at least one programmable processor; and
a machine-readable medium storing instructions that, when executed by the at least one processor, cause the at least one programmable processor to perform operations comprising:
detecting a status change relating to at least one instance of at least one data structure underlying at least one business process of a customer organization of a sales force automation solution;
applying one or more feed content generation rules to the detected status change, the one or more feed content generation rules comprising a definition of a key performance indicator relating to a business outcome of the customer organization;
creating a feed content item based on the status change, the feed content item relating to progress toward or achievement of the key performance indicator; and
providing, via a feed bot service, the feed content item to business users registered with the feed bot service, the business users registered with the feed bot service comprising at least one business user who is not directly registered to receive notifications about status changes in the at least one data structure or business process.

8. A system as in claim 7, wherein the business process relates to a sales opportunity of the customer organization.

9. A system as in claim 7, wherein the operations further comprise attaching a custom icon to the content item, the custom icon distinguishing the feed content item as being delivered by the feed bot service.

10. A system as in claim 7, wherein the feed bot service comprises a competitive win feed bot service, the feed content item comprises one or more details regarding an instance in which the customer organization won an opportunity against a competitor, and the one or more feed content generation rules comprises a definition of the competitor.

11. A system as in claim 7, wherein the feed bot service comprises an automatic applause feed bot service, the feed content item comprises one or more details regarding an instance in which an opportunity with a high volume was created for the customer organization, and the one or more feed content generation rules comprises a definition of the high volume.

12. A system as in claim 7, wherein the feed bot service comprises a stalled opportunity feed bot service, the feed content item comprises one or more details regarding an opportunity of the at least one business user that has become stalled or is no longer progressing according to one or more defined metrics, and the one or more feed content generation rules comprises the one or more defined metrics.

13. A computer-implemented method comprising:
detecting a status change relating to at least one instance of at least one data structure underlying at least one business process of a customer organization of a sales force automation solution;
applying one or more feed content generation rules to the detected status change, the one or more feed content generation rules comprising a definition of a key performance indicator relating to a business outcome of the customer organization;
creating a feed content item based on the status change, the feed content item relating to progress toward or achievement of the key performance indicator; and
providing, via a feed bot service, the feed content item to business users registered with the feed bot service, the business users registered with the feed bot service comprising at least one business user who is not directly registered to receive notifications about status changes in the at least one data structure or business process.

14. A computer-implemented method as in claim 13, wherein the business process relates to a sales opportunity of the customer organization.

15. A computer-implemented method as in claim 13, further comprising attaching a custom icon to the content item, the custom icon distinguishing the feed content item as being delivered by the feed bot service.

16. A computer-implemented method as in claim 13, wherein the feed bot service comprises a competitive win feed bot service, the feed content item comprises one or more details regarding an instance in which the customer organization won an opportunity against a competitor, and the one or more feed content generation rules comprises a definition of the competitor.

17. A computer-implemented method as in claim 13, wherein the feed bot service comprises an automatic applause feed bot service, the feed content item comprises one or more details regarding an instance in which an opportunity with a high volume was created for the customer organization, and the one or more feed content generation rules comprises a definition of the high volume.

18. A computer-implemented method as in claim 13, wherein the feed bot service comprises a stalled opportunity feed bot service, the feed content item comprises one or more details regarding an opportunity of the at least one business user that has become stalled or is no longer progressing according to one or more defined metrics, and the one or more feed content generation rules comprises the one or more defined metrics.

19. A computer-implemented method as in claim 13, wherein at least one of the detecting, the applying, the creating, and the providing is performed by at least one programmable processor.
